(19) United States
(12) Patent Application Publication
(10) Pub. No.: US 2021/0182736 A1
(43) Pub. Date: Jun. 17, 2021

(54) LEARNING DATA GENERATION DEVICE, LEARNING DATA GENERATION METHOD, AND NON-TRANSITORY COMPUTER READABLE RECORDING MEDIUM

(71) Applicant: NIPPON TELEGRAPH AND TELEPHONE CORPORATION, Tokyo (JP)

(72) Inventors: Takaaki HASEGAWA, Tokyo (JP); Yoshiaki NODA, Tokyo (JP); Setsuo YAMADA, Tokyo (JP)

(73) Assignee: NIPPON TELEGRAPH AND TELEPHONE CORPORATION, Tokyo (JP)

(21) Appl. No.: 17/268,472

(22) PCT Filed: Aug. 14, 2019
(86) PCT No.: PCT/JP2019/031934

§ 371 Date: Feb. 14, 2021

(30) Foreign Application Priority Data
Aug. 15, 2018 (JP) 2018-152893

(51) Int. Cl. G06N 20/00

(52) U.S. Cl. CPC G06N 20/00

(57) ABSTRACT

Disclosed is an approach for efficiently generating training data necessary for the learning of models when performing classification entailing hierarchical combination of classifiers. Learning data generation device (1) comprises: a learning scope determination unit (15) configured to determine input data to be a learning scope, on the basis of classification results from a multi-class classification of the input data group using the plurality of classifiers; and a training data generation unit (16) configured to generate training data that is the input data determined to be the learning scope to which the classification results of the input data are appended as labels.

### TECHNICAL FIELD

The present invention relates to a learning data generation device, a learning data generation method, and a program, for generating learning data.

### BACKGROUND

Machine learning techniques may be broadly classified as trained learning in which learning is performed whilst adding ground truth labels to learning data, untrained learning in which learning is performed without adding labels to learning data, and reinforcement learning in which a computer is induced to autonomously derive an optimal method by rewarding good results. For example, a support vector machine (SVM) that performs class classification is known as an example of trained learning (see, NPL 1).

### CITATION LIST

### Non-Patent Literature

NPL 1: Hiroya Takamura, “An Introduction to Machine Learning for Natural Language Processing”, CORONA PUBLISHING CO., LTD., 2010 Aug. 5, pp. 117-127.

### SUMMARY

### Technical Problem

By hierarchically combining multiple classifiers, it is also possible to perform a more advanced classification. However, in doing so, because it is necessary to build and/or update classifiers necessary for each individual classification, a problem arises in that that correction of classification results and generation of learning data are time and effort intensive.

An objective of the present invention, made in view of the above background, is to provide a learning data generation device, a learning data generation method, and a program, that can efficiently generate learning data necessary for the learning of models when performing classification entailing a hierarchical combination of classifiers.

### Solution to Problem

In order to solve the abovementioned problem, a learning data generation device of the present invention is a learning data generation device for generating learning data in a system that performs classification of an input data group using a plurality of classifiers that are combined hierarchically, and comprises: a learning scope determination unit for determining input data to be a learning scope, on the basis of classification results from a multi-class classification of the input data group using the plurality of classifiers; and a training data generation unit for generating training data that is the input data determined to be the learning scope to which the classification results of the input data are appended as labels.

Further, in order to solve the abovementioned problem, a learning data generation method of the present invention is a learning data generation method for generating learning data in a system that performs classification of an input data group using a plurality of classifiers that are combined hierarchically, and comprises: determining input data to be a learning scope, on the basis of classification results from a multi-class classification of the input data group using the plurality of classifiers; and generating training data that is the input data determined to be the learning scope to which the classification results of the input data are appended as labels.

Further, in order to solve the abovementioned problems, a program pertaining to present invention causes a computer to function as the abovementioned learning data generation device.

### Advantageous Effect

According to the present invention, it is possible to efficiently generate learning data necessary for the learning of models when performing a classification that entails a hierarchical combination of classifiers.

### BRIEF DESCRIPTION OF THE DRAWINGS

In the accompanying drawings:

FIG. 1 is a schematic block diagram illustrating an example configuration of the learning data generation device according to an embodiment of present invention;

FIG. 2 is a diagram showing an example of input data group classification using multi-class classifiers;

FIG. 3 is a diagram showing an example of a classification dependency relation table generated by the learning data generation device according to an embodiment of the present invention;

FIG. 4 is a diagram showing an example of a classification results table generated by the learning data generation device according to an embodiment of the present invention;

FIG. 5 is a diagram showing an example of a learning form generated by the learning data generation device according to an embodiment of the present invention;

FIG. 6 is a diagram showing a first correction example of a learning form generated by the learning data generation device according to an embodiment of the present invention;

FIG. 7 is a diagram showing an example of a second correction example of a learning form generated by the learning data generation device according to an embodiment of the present invention;

FIG. 8 is a diagram showing an example of a third correction example of a learning form generated by the learning data generation device according to an embodiment of the present invention;

FIG. 9 is a diagram showing an example of a fourth correction example of a learning form generated by the learning data generation device according to an embodiment of the present invention;

FIG. 10 is a diagram showing an example of correction information generated by the learning data generation device according to an embodiment of the present invention;

FIG. 11 is a diagram showing an example of correction of a classification results table generated by the learning data generation device according to an embodiment of the present invention;

FIG. 12 is a diagram showing an example of training data generated by the learning data generation device according to an embodiment of the present invention; and

FIG. 13 is a flow chart showing an example of the operations of a learning data generation method according to an embodiment of the present invention.

### DETAILED DESCRIPTION

Hereinafter, embodiments of the present invention will be described with reference to the drawings.

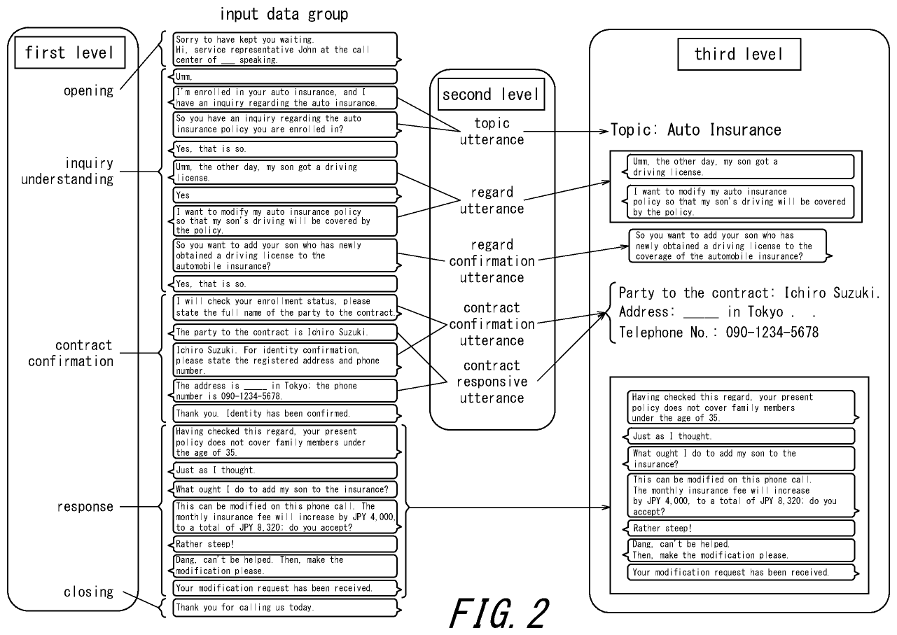

Firstly, a system for classifying input data groups using multiple classifiers that are hierarchically combined is explained. FIG. 2 is a diagram showing an example of a classification of an input data group using multi-class classifiers. In the example of FIG. 2, documents indicating the dialogue from telephonic activity and chat activity between a customer and a service person (e.g. an operator) are assumed to be an input data group. Moreover, a dialogue scene is predicted by a first level (top level) classifier (hereinafter, “primary classifier”), an utterance type is predicted by a second level classifier (hereinafter, “secondary classifier”), and utterance focus point information is predicted or extracted by a third level classifier (hereinafter “tertiary classifier”). The utterance focus point information can be information that is based on part or all of the utterances deemed to correspond to the utterance type, or information based on an analysis of the utterances deemed to correspond to the utterance type. Moreover, speech balloons positioned on the right side are segments that indicate the utterance content of the operator, and speech balloons positioned on the left side are segments that indicate the utterance content of the customer. Segments representing utterance content may be segmented at arbitrary positions to yield utterance units (input data units), and each speech balloon in FIG. 2 stipulates input data of an utterance unit. Below, a system for classifying an input data group using these three-levels of classifiers according to the present embodiment will be described.

The primary classifier uses a dialogue scene prediction model to predict the dialogue scene in a contact center, and in the example given in FIG. 2, classification into five classes is performed: opening, inquiry understanding, contract confirmation, response, and closing. An opening is a scene in which dialogue initiation confirmation is performed, such as “Sorry to have kept you waiting. Hi, service representative John at the call center of ______ speaking.”.

Inquiry understanding is a scene in which the inquiry content of the customer is acquired, such as: “I'm enrolled in your auto insurance, and I have an inquiry regarding the auto insurance.”, “So, you have an inquiry regarding the auto insurance policy you are enrolled in?”, “Umm, the other day, my son got a driving license. I want to change my auto insurance policy so that my son's driving will be covered by the policy; can you do this?”, “So, you want to add your son who has newly obtained a driving license to your automobile insurance?”.

Contract confirmation is a scene in which contract confirmation is performed, such as: “I will check your enrollment status, please state the full name of the party to the contract.”, “The party to the contract is Ichiro Suzuki.”, “Ichiro Suzuki. For identity confirmation, please state the registered address and phone number.”, “The address is ______ in Tokyo, and the phone number is 090-1234-5678.”, “Thank you. Identity has been confirmed.”.

Response is a scene in which a response to an inquiry is performed, such as “Having checked this regard, your present policy does not cover family members under the age of 35.”, “What ought I do to add my son to the insurance?”, and “This can be modified on this phone call. The monthly insurance fee would increase by JPY 4,000, to a total of JPY 8,320; do you accept?”.

Closing is a scene in which dialogue termination confirmation is performed, such as “Thank you for calling us today.”.

The secondary classifier further predicts, with respect to the dialogue for which the dialogue scene was predicted by the primary classifier, the utterance type in an utterance-wise manner. The secondary classifier may use multiple models to predict multiple kinds of utterance types. In the present embodiment, with respect to a dialogue for which the dialogue scene is predicted to be inquiry understanding, a topic utterance prediction model is used to predict whether, in an utterance-wise manner, utterances are topic utterances; a regard utterance prediction model is used to predict whether, in an utterance-wise manner, utterances are regard utterances; and a regard confirmation utterance prediction model is used to predict whether, in an utterance-wise manner, utterances are regard confirmation utterances. Further, with respect to a dialogue for which the dialogue scene is predicted to be contract confirmation, a contract confirmation utterance prediction model is used to predict whether, in an utterance-wise manner, utterances are contract confirmation utterances; and a contract responsive utterance prediction model is used to predict whether, in an utterance-wise manner, utterances are contract responsive utterances.

A topic utterance is an utterance by the customer that is intended to convey the topic of the inquiry. A regard utterance is an utterance by the customer that is intended to convey the regard of the inquiry. A regard confirmation utterance is an utterance by the service person that is intended to confirm the inquiry regard (e.g. a readback of the inquiry regard). A contract confirmation utterance is an utterance of the service person that is intended to confirm the details of the contract. A contract responsive utterance is an utterance by the customer that is intended to, with respect to the contract content, provide a response to the service person.

The tertiary classifier predicts or extracts, on the basis of the classification results of the primary and secondary classifiers, utterance focus point information. Specifically, from utterances predicted by the secondary classifier to be topic utterances, the focus point of the topic utterances information is predicted using the topic prediction model. Further, from utterances predicted by the secondary classifier to be regard utterances, the entirety of the text is extracted as the focus point information of the regard utterances, and from utterances predicted by the secondary classifier to be regard confirmation utterances, the entirety of the text is extracted as the focus point information of the regard confirmation utterances. Further, from utterances predicted by the secondary classifier to be contract confirmation utterances and utterances predicted to be contract responsive utterances, the name of the party to the contract, the address of the party to the contract and the telephone number of the party to the contract are extracted. The extraction of the name of the party to the contract, the address of the party to the contract and the telephone number of the party to the contact may be performed using models and also may be performed in accordance with pre-stipulated rules.

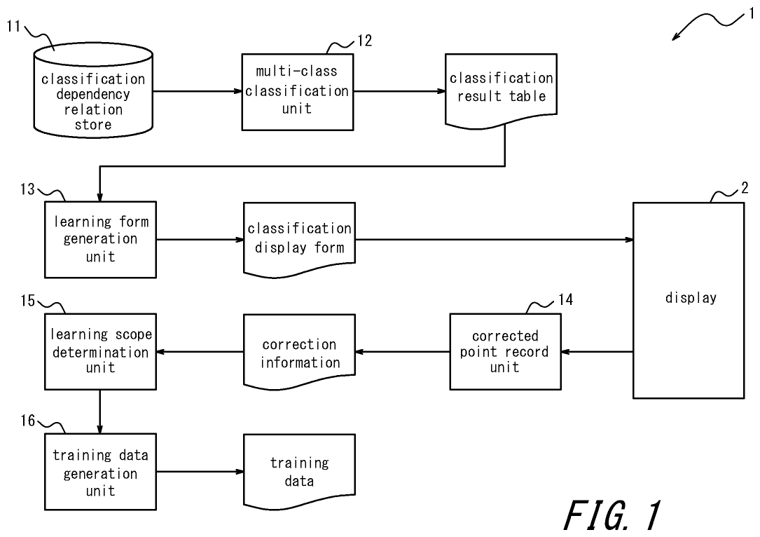

FIG. 1 is a schematic diagram illustrating an example configuration of the learning data generation device according to an embodiment of present invention. The learning data generation device 1 of FIG. 1 comprises a classification dependency relation store 11, a multi-class classifier 12, a learning form generation unit 13, a corrected point record unit 14, a learning scope determination unit 15, and a training data generation unit 16. The learning data generation device 1 may have a display 2 and the display 2 may be arranged external to the learning data generation device 1.

The Learning data generation device 1 is a device that generates learning data for models in a system for classifying input data groups using multiple classifiers that are hierarchically combined.

The classification dependency relation store 11 stores, in relation to each classification, a classification dependency relation table that defines an order in which the classifiers are performed (classifier combinations). The classification dependency relation table defines the classifiers to be used at each level and their conditional values.

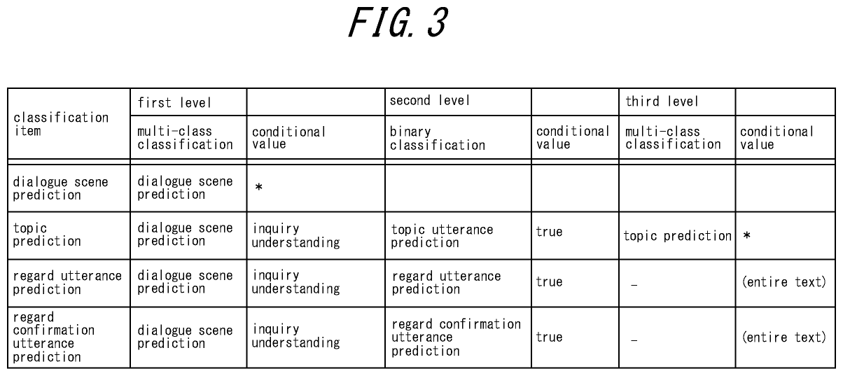

FIG. 3 is a diagram showing an example classification dependency relation table. For example, in a case in which the classification item is topic prediction, the primary classifier performs dialogue scene prediction at the first level, and in a case in which the multivalued classification result is “inquiry understanding”, proceeds to the second level. At the second level, the secondary classifier performs topic utterance prediction, and in a case in which the binary classification result is “true”, proceeds to the third level. At the third level, the tertiary classifier performs topic prediction, and outputs a multivalued classification result. Further, in a case in which the classification item is regard utterance prediction, the primary classifier performs dialogue scene prediction at the first level, and in a case in which the multivalued classification result is “inquiry understanding”, proceeds to the second level. At the second level, the secondary classifier performs regard utterance prediction, and in a case in which the binary classification result is “true”, proceeds to the third level. At the third level, the entirety of the text is unconditionally outputted.

The multi-class classifier 12 reads out the classification dependency relation table from the classification dependency relation store 11 and, in accordance with the classification dependency relation table, performs a multi-class classification with respect to the input data group, and generates and saves a classification results table representative of the classification results. Here, any known method such as SVM, deep neural network (DNN) and the like may be applied as the classification method. With regards to DNN, models appropriate for dealing with time-series data such as Recurrent Neural Network (RNN), Long Short-Term Memory (LSTM) and the like may be utilized. Further, classification may be performed in accordance with pre-stipulated rules. The rules may include exact matching on the string or word; forward-matching; backward-matching; partial matching; and besides these, matching based on regex.

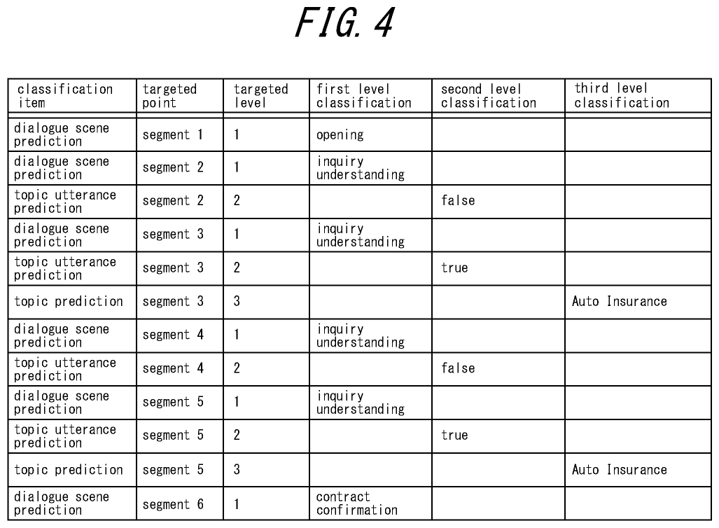

FIG. 4 is a diagram showing an example of a classification results table generated, prior to manual correction, by the multi-class classifier 12. For each classification, the “targeted point” is a number for identifying which segment out of the documents constituting the input data was targeted for classification execution. The “targeted level” indicates the level of the classification within the dependency hierarchy, i.e. the level of the classifier that classified the segment indicated in the targeted point. “First level classification” indicates classification results of the primary classifier, “second level classification” indicates classification results of the secondary classifier, and “third level classification” indicates classification results of the tertiary classifier.

The learning form generation unit 13 generates a learning form having classification results based on the classification results table generated by the multi-class classifier 12 and a correction interface for rectifying said classification results, and causes the learning form to be displayed on the display 2. The correction interface is an object for rectifying the classification results and is associated with the classification level and the targeted point.

Specifically, the learning form generation unit 13 generates a learning form which shows, in a categorized manner for the respective classification results, the classification results from the first level (top level) classifier, and shows, within the region for displaying the classification results by the first level classifier, classification results by the classifiers of the respective lower levels.

Further, the learning form generation unit 13 generates a correction interface including buttons for adding classification results, buttons for deleting classification results, and regions for inputting corrected classification results. Moreover, in some embodiments modification may be possible by clicking the classification results display region, and in this case the classification results display region and the post-correction classification results input area become one and the same.

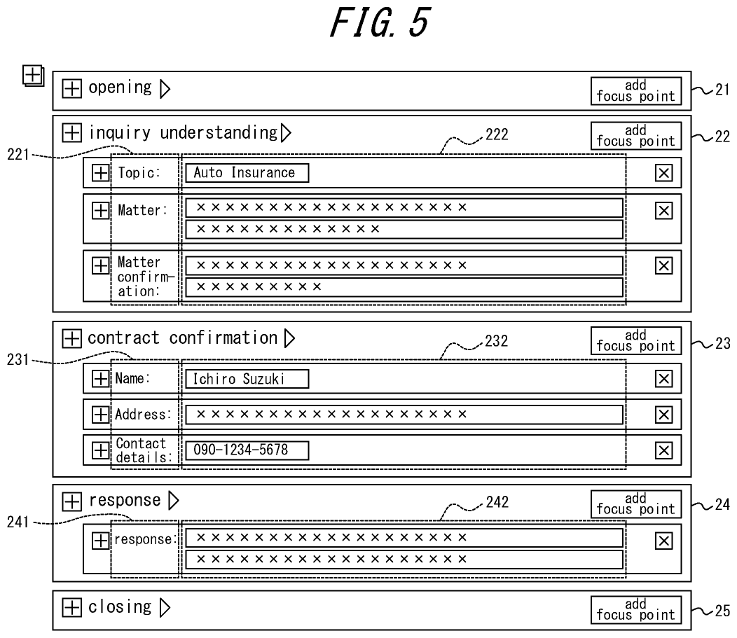

FIG. 5, similar to FIG. 2, is a diagram showing an example learning form in a case in which a classifier is caused to perform classification based on a dialogue between the customer and the service person as the input data. The learning form has primary display regions 21 through 25 for showing, in a categorized manner for the respective classification results, the classification results from the primary classifiers. Each of the primary display regions may, in a case in which there are classification results from the secondary classifiers, have a secondary display region for displaying the corresponding classification results; and in a case in which there are classification results (inclusive of extraction results of utterance focus point information) from the tertiary classifiers, have a tertiary display region for displaying the corresponding classification results. Only classification results with a value of “true” are displayed for the secondary classifier classification results, and the tertiary classified classification results are displayed adjacent to the secondary classifier classification results.

In FIG. 5, in a case in which the classification result is “true” when the topic utterance prediction model is used as the secondary classifier, “topic” is displayed; in a case in which the classification result is “true” when the regard utterance prediction model is used as the secondary classifier, “regard” is displayed; and in a case in which the classification result is “true” when the regard confirmation utterance prediction model is used as the secondary classifier, “regard confirmation” is displayed. Further, in a case in which the classification result is “true” when the contract confirmation utterance prediction model or contract responsive utterance prediction model is used as the secondary classifier, “name”, “address”, and/or “contact details” are displayed.

Specifically, the primary display region 21 displays only “opening” which is the classification result of the primary classifier, and the primary display region 25 displays only “closing” which is the classification result of the primary classifier.

The primary display region 22 displays “inquiry understanding” which is the classification result of the primary classifier. If the classification dependency relation table is followed, in a case in which the classification result of the primary classifier is “inquiry understanding”, the processing proceeds to the second level. Then, utterance type prediction is performed at the second level and, in a case in which the result of this is “true”, the processing proceeds to the third level. For this purpose, the primary display region 22 displays, in secondary display region 221, “topic”, “regard”, and “regard confirmation”, which indicate that the classification results at the secondary classifier is “true”. Further, the classification results relating to topic utterances and extraction results relating to utterance focus point information of regard utterances and regard confirmation utterances are displayed in the tertiary display region 222. Moreover, as extraction results relating to utterance focus point information of regard utterances and regard confirmation utterances are often similar, only one of them may be displayed.

Similarly, the primary display region 23 displays “contract confirmation” which is the classification result of the primary classifier, and “name”, “address”, and “contact details”, which indicate that the classification result at the secondary classifier is “true”. Further, with respect to “name”, “address”, and “contact details”, extraction results pertaining to utterance focus point information are displayed in the tertiary display region 232.

In the example shown in FIG. 2, in a case in which the classification result of the primary classifier is “response”, classification by the secondary classifier is not performed, and the entirety of the text of the utterance for which the dialogue scene was predicted to be “response” is extracted. Thus, although the primary display region 24 need not have the secondary display region, in the interest of readability and in a manner similar to primary display regions 22, 23, a secondary display region 241 is provided in FIG. 5 and “response” is displayed therein. Further, with respect to “response”, extraction results pertaining to utterance focus point information is displayed in the tertiary display region 242.

Further, as part of the correction interface, in the primary display regions 21 to 25, “add focus point” buttons for adding utterance focus point information are displayed, and in the primary display regions 22 to 24, “X” buttons, shown by X symbols, for deleting utterance focus point information are displayed.

With respect to the third level topic prediction results shown in the tertiary display region 222, in a case in which the prediction is from multiple candidates, a user can select from a pulldown to perform a correction and save action. Further, with respect to the third level utterance focus point information extraction results shown at tertiary display regions 232, 242, the user can rectify and save the text. Unnecessary utterance focus point information can be deleted by depressing the “X” button.

The corrected point record unit 14 generates correction information that records the correction point and the corrected classification results in a case in which the learning form generated by the learning form generation unit 13 has been corrected by the user via the correction interface (i.e. in a case in which the classification results have been corrected). Moreover, the user can perform corrections on classification results in the midst of the multiple levels, via buttons associated with the classification levels. Correction includes modification, addition, and deletion. In a case in which the classification result of the top level classifier has been corrected, the corrected point record unit 14 changes said classification result (in the present embodiment, the dialogue scene corresponding to dialogue content) and generates correction information. The training data can entail only the correction information of the top level classifier, the classification results from initial servicing up to the correction information, or all classification results including correction information. For example, in the present embodiment, in a case in which the classification result of the dialogue scene prediction of the primary classifier was corrected from “inquiry understanding” to “response”, the classification result of the primary classifier is changed from “inquiry understanding” to “response”. The learning scope can be set to at least each utterance up to the utterance for which the classification result was corrected and time-series data of that classification result, and may be set to time series data of the classification results of all successive utterances including the utterance for which the classification result was corrected.

Further, in a case in which a classification result of a classifier of a particular level is corrected, the corrected point record unit 14 also corrects classification results of classifiers at levels higher than said particular level in conformance with the classification result correction. In a case in which there is no need to rectify the classification results of the top level classifier, it can be left at that. For example, in the present embodiment, even if the classification result of the topic utterance prediction by the secondary classifier was left at “true” and not subjected to correction, in a case in which the classification result of the topic prediction by the tertiary classifier was deleted, because it implies that the classification result of the secondary classifier was incorrect, the classification result of the secondary classifier is corrected from “true” to “false”. It suffices to go back to the binary classification at the second level, and it is not necessary to go back to the first level.

Further, corrected point record unit 14 may, in a case in which a classification result of a classifier of a particular level is corrected, also exclude, from the training data, classification results of classifiers of levels lower than said particular level in conformance with the classification result correction. For example, in the present embodiment, in a case in which the classification result of dialogue scene prediction by the primary classifier is corrected from “inquiry understanding” to “response” and in a case in which the classification result of the regard utterance prediction by the secondary classifier is predicted to be “true”, then “true” is excluded from the training data. Moreover, the corrected point record unit 14 checks for the existence of corrections from the higher levels and if there are no corrections, it then checks for existence of corrections at the lower levels. Thus, hypothetically, even if the user, after having corrected the topic prediction classification result of the tertiary classifier, went on to rectify the dialogue scene prediction classification result of the primary classifier, the topic prediction correction of the tertiary classifier would, in a case in which the dialogue scene prediction of the primary classifier is not “inquiry understanding”, be deleted from the training data because the corrected point record unit 14 checks from the corrections at the first level.

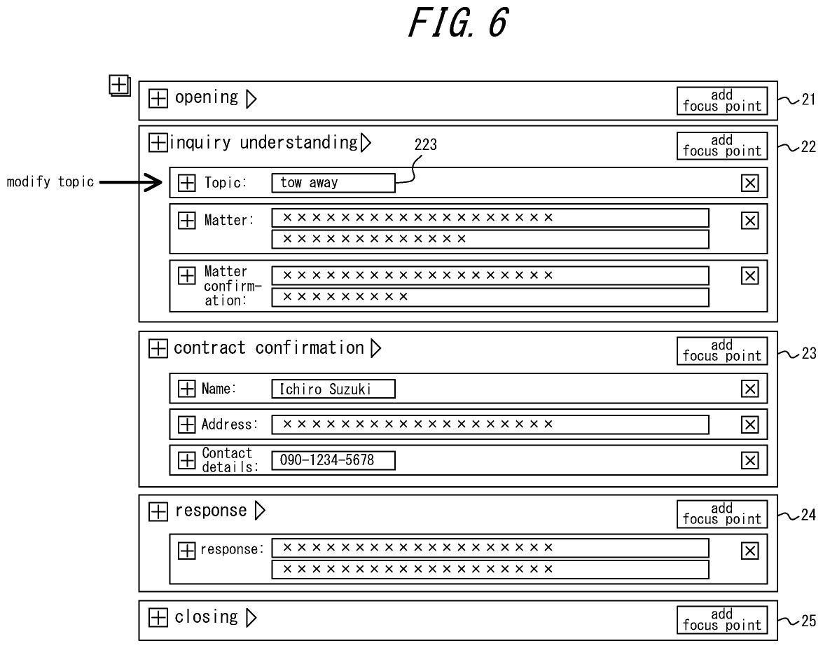

FIG. 6 shows a first example of correction in the learning form. The user can modify the topic displayed in the topic display region 223. For example, when the topic display region 223 displaying topic prediction results is clicked on by the user, the display 2 displays a pulldown listing the selectable topics. The user can, by selecting one or more topics from the listing of topics, modify the topic. In this example, the user, modifies the third level topic prediction result of “auto insurance” displayed in the primary display region 22 to “tow away”. Where such a correction is performed, corrected point record unit 14 changes the third level topic prediction result from “auto insurance” to “tow away”.

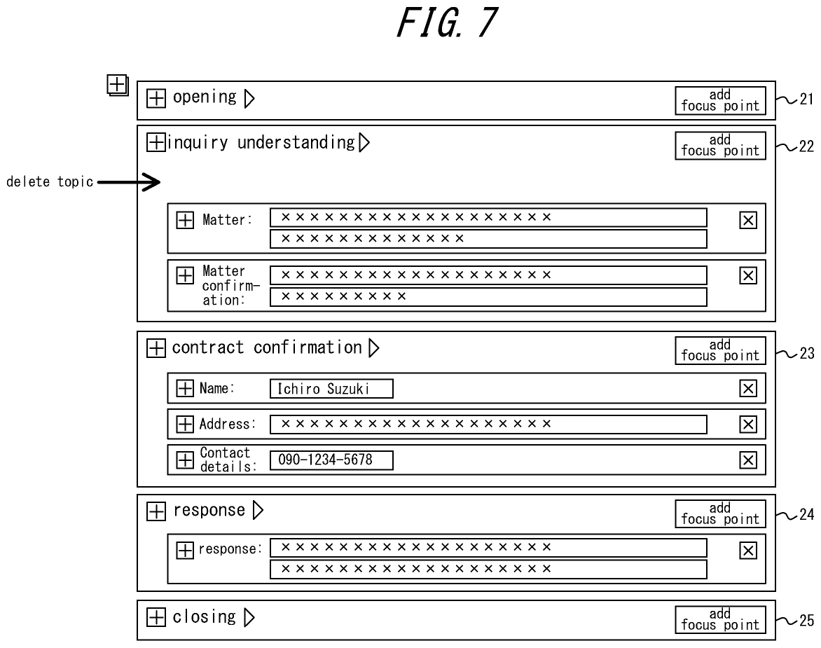

FIG. 7 shows a second example of correction in the learning form. If the “X” button is depressed by the user, the display 2 stops displaying the second and third levels. In this example, the user deletes the utterance type “topic”, that is a second level prediction result of “true” shown in the primary display region 22. Where such a correction is performed, corrected point record unit 14 deletes the third level topic prediction result together with changing the second level topic utterance prediction result from “true” to “false”.

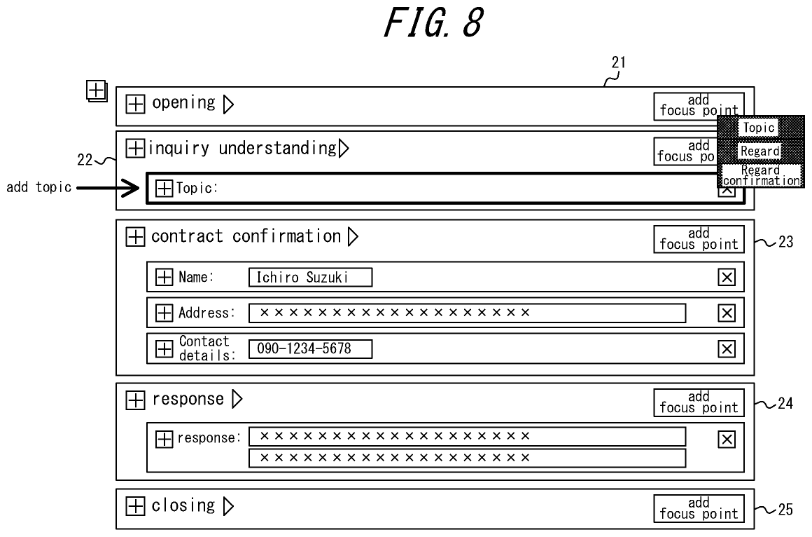

FIG. 8 shows a third example of correction in the learning form. If the “add focus point” button is depressed by the user, the display 2 displays a pulldown list of buttons that can be selected regarding the utterance types corresponding to the utterance focus point information that can be added. If any of the buttons shown in the pulldown superimposed on the “add focus point” button is selected, the utterance focus point information input field corresponding to the utterance type indicated by the selected button is displayed. Shown here is an example regarding addition of a “topic” input field, in which the user depresses the “add focus point” button shown in the primary display region 22, and selects “topic” from “topic”, “regard”, and “regard confirmation” displayed in the pulldown. When such a correction is performed, the corrected point record unit 14 changes the second level topic utterance prediction result from “false” to “true”.

Moreover, in a case in which topic addition is concerned, the user can, by selecting via clicking and the like on separately displayed utterance data, establish an association with utterances corresponding to the topic. For example, in a case in which, in the interest of differentiation from other utterance data, a prescribed background color is to be applied to utterance data predicted, by the topic utterance prediction model, to be a topic utterance, a scenario in which the topic utterance prediction model prediction is erroneous may occur; this scenario causing non-application of the background color necessary for inducing the service person to recognize that the utterance data concerns a topic utterance. In this case, by clicking on the utterance data recognized as being a topic utterance, the prescribed background color will be applied. Further, if the prescribed background color has been applied on the utterance data on the basis of the operations of the service person, utterance types may be added in correspondence to the utterance data.

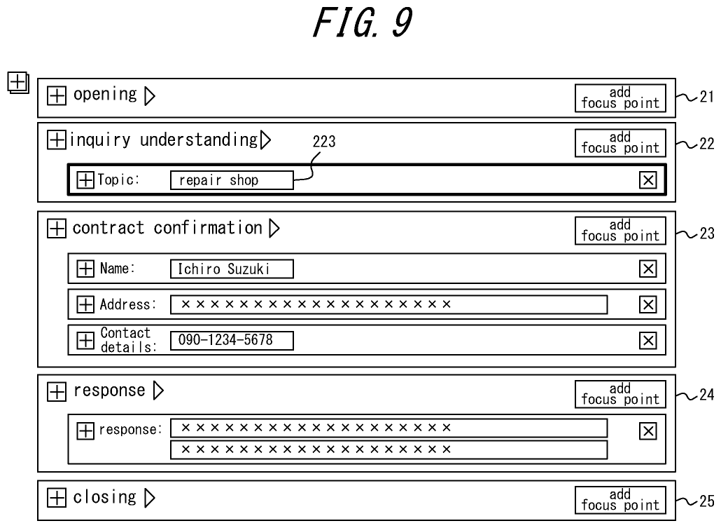

FIG. 9 shows a fourth example of correction in the learning form. As shown in FIG. 8, even with situations in which a topic has been added, were the topic display region 223 displaying topic prediction results to be clicked upon by the user, the display 2 will display via pulldown action a list of the selectable topics. Shown here is an example regarding topic prediction entailing clicking, after the user having added the “topic”, the topic display region 223 and selecting “repair shop” from the listing of topics displayed in the pulldown. In a case which such a correction is performed, corrected point record unit 14 adds “repair shop” as a third level topic prediction result.

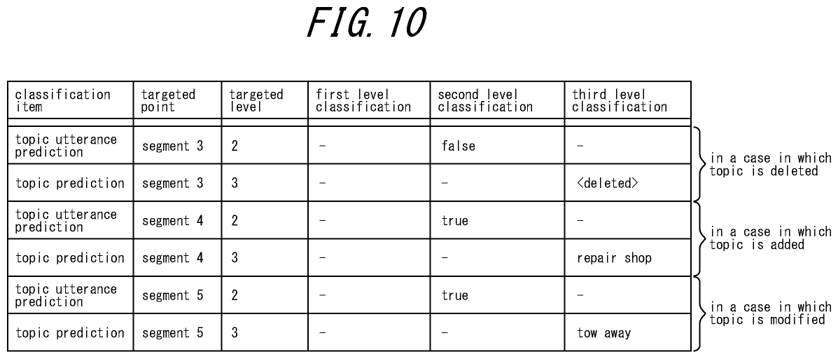

FIG. 10 is a diagram illustrating an example of correction information generated by the corrected point record unit 14. Correction information concerning the correction shown in FIGS. 6 to 9 and performed by the user is shown. The format of the correction information is the same as the classification dependency relation table. With respect to segment 3, in a case in which the user deletes the “topic” as shown in FIG. 7, the corrected point record unit 14 deletes the third level topic prediction result of segment 3. Further, because the user understands that the utterance type of segment 3 is not a topic utterance, the corrected point record unit 14 changes the second level topic utterance prediction result to “false”.

With respect to segment 4, in a case in which the user adds “topic”, as shown in FIGS. 8 and 9, the corrected point record unit 14 adds “repair shop” as the third level topic prediction result for segment 4. Further, because the user understands that the utterance type of segment 4 is a topic utterance, the corrected point record unit 14 changes the second level topic utterance prediction result to “true”.

With respect to segment 5, in a case in which the user modifies the “topic”, as shown in FIG. 6, the corrected point record unit 14 changes the third level topic prediction result for segment 5 to “tow away”. Further, because the user understands that the utterance type of segment 5 is a topic utterance, the corrected point record unit 14 maintains the second level topic utterance prediction result as “true”.

The learning scope determination unit 15 reflects the correction information generated by corrected point record unit 14 in the classification results table generated by the multi-class classifier 12. Then, the learning scope determination unit 15 determines the learning scope based of the classification results. The learning scope determination unit 15 may also include the first level for which the user has not performed correction within the learning scope. For example, by depressing a confirmation button provided in the learning form, even in a case in which there is no correction by the user, this may be included in the learning scope. The learning scope may be configured for each level by providing a confirmation button for the entirety of the dialogue, a confirmation button for each dialogue scene of the first level, or a confirmation button for confirming the subordinate levels, i.e. the second and third levels.

For example, the learning scope determination unit 15 determines the learning scope to be one or more consecutive input data including input data corresponding to the corrected classification results and having the same classification results of the first level (top level) classifier. That is, it is determined that the learning scope (the training data scope) is to be a consecutive range including corrected points and having the same classification results of the first level classifier, and within the learning scope, not only corrected information but also non-corrected information is set as a target of the training data. Even if there is a range in which the same classification results are consecutive in the first level, in a case in which points corrected by the user are not included and the abovementioned confirmation button is not provided, because it is not possible to determine whether the user has performed a confirmation with respect to the classification results of said range, they are not included in the learning scope. On the other hand, in a case in which the user has performed correction, because it can be considered that the user has performed confirmation for the range in which the same classification results of the first level classifier are consecutive, it is set as a target for the training data.

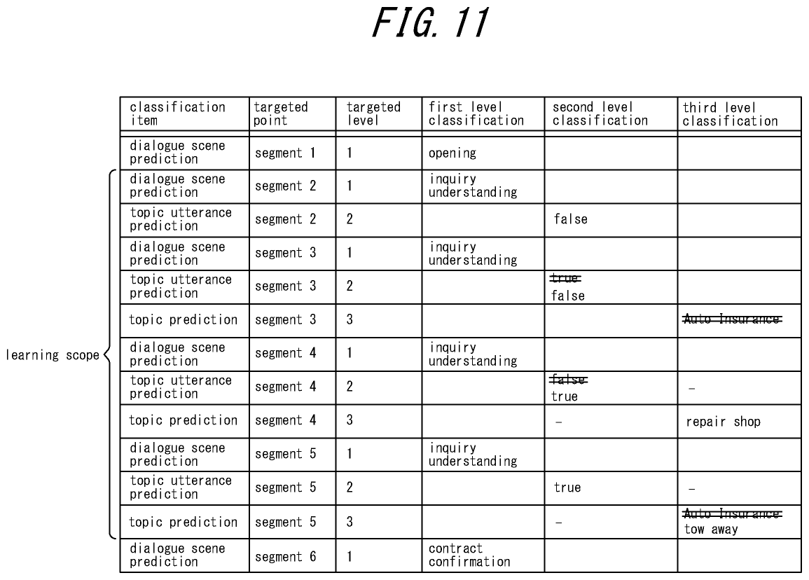

FIG. 11 shows an example of correction of the classification result table shown in FIG. 4. For explanatory purposes, strike-outs have been superimposed on content that has been changed or deleted. The learning scope is the scope in which the correction points are the same and are consecutive. As shown in FIG. 11, in a case in which the third topic prediction result “auto insurance” of segment 3 has been deleted, the learning scope is segment 2 to segment 5, for which the first level classification result is “inquiry understanding”. Similarly, in a case in which the third level classification result of segment 4 or segment 5 has been corrected, the learning scope is segment 2 to segment 5. Though the user did not rectify the classification result of segment 2, because “inquiry understanding” is shared with the first level classification result, segment 2 is also in the learning scope.

On the other hand, according to the example of FIG. 11, with respect to segment 1 and segment 6, because there are no user corrections made to the classification results and as the first level classification result is not “inquiry understanding”, segment 1 and segment 6 are not in the learning scope. That is, with respect to the dialogue scenes of “opening” and “contract confirmation”, it is not possible to determine whether the user has performed confirmation because the user has not made any corrections to the classification results. Thus, in such cases, they are not included in the learning scope.

The training data generation unit 16, with respect to the learning scope determined by learning scope determination unit 15, generates training data from the respective classification items/segments/labels, by associating correction information with the multi-class classification results and updating. In a case in which the third level classification results are deleted, because the ground truth is unclear, the training data generation unit 16 excludes corresponding classification items from the training data.

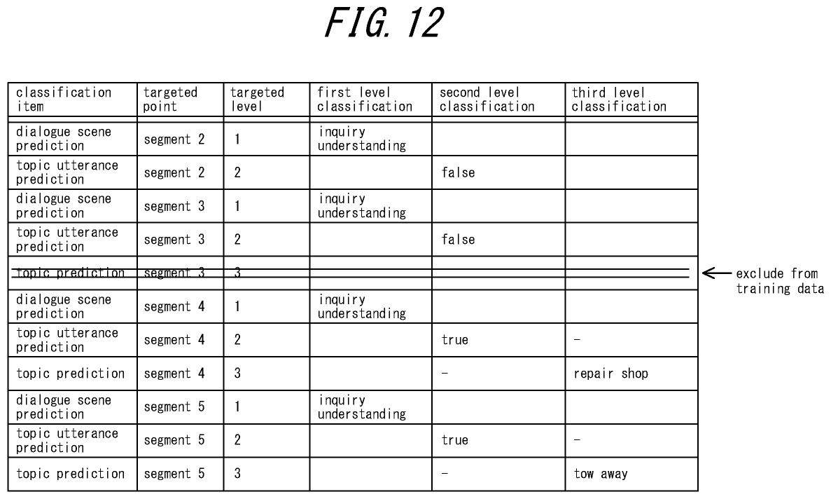

FIG. 12 shows an example of training data. The segments included in the training data need not be the actual data of the segments, and may be identification numbers of the segments as shown for the targeted points of FIG. 12. Further, according to FIG. 12 the labels included in the training data show the targeted levels, the first level classifications, the second level classifications, and the third level classifications. According to this example, because the third level classification result of the targeted point “segment 3” with the classification item “topic prediction” is deleted, this is excluded from the training data.

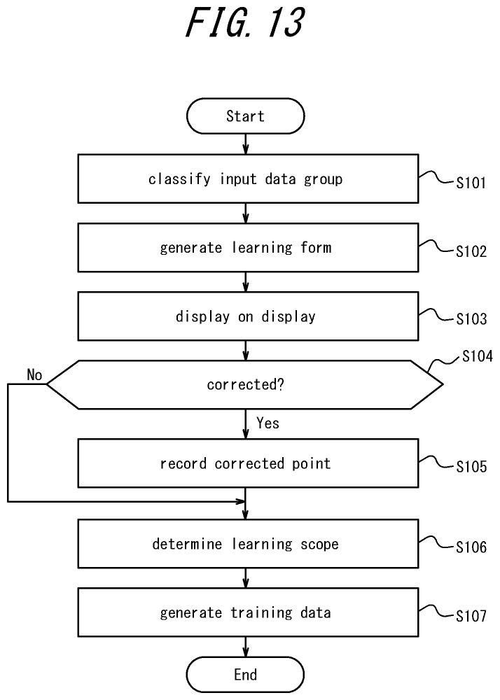

Next, the learning data generation method pertaining to the learning data generation unit 1 will be explained. FIG. 13 is a flow chart showing how an operation example of a learning data generation method according to an embodiment of the present invention.

The learning data generation unit 1, using the multi-class 12, classifies the input data groups (S101). Moreover, in relation to the abovementioned embodiment, though an explanation has been provided for a case having a hierarchy of three levels, cases involving more than three levels may also be conceived. That is, no limitation on the number of levels is set for the present invention. For example, in a case in which classification is performed at two levels, dialogue scene prediction would be performed at the first level, and the second level regard utterance prediction would only be performed in a case in which the dialogue scene prediction result is “inquiry understanding”. Further, in a case in which classification is performed at four levels, the result from the third level topic prediction would be subclassified at the fourth level. For example, in a case in which it is predicted that the topic is “auto insurance” at the third level, the fourth level would entail classification into any of “new contract”, “modification”, “cancellation”.

Next, the learning data generation device 1 generates, using the learning form generation unit 13, a learning form (S102), and causes the classification results to be displayed on the display 2 (S103).

When the classification results displayed on the display 2 are corrected by the user (S104—Yes), the learning data generation device 1 records the corrected point using the corrected point record unit 14 (S105). Then, the learning scope is determined using the learning scope determination unit 15 (S106), and training data is generated using the training data generation unit 16 (S107). In a case in which the classification results displayed on the display 2 are not corrected by the user (S104—No), step S105 is not performed and the processing of steps S106 and S107 are performed.

Moreover, a computer can be used to realize the functions of the abovementioned learning data generation device 1, and such a computer can be realized by causing a CPU of the computer to read out and execute a program, wherein the program describes procedures for realizing the respective functions of the learning data generation device 1 and is stored in a database of the computer.

Further, the program can be recorded on a computer readable medium. By using the computer readable medium, installation on a computer is possible. Here, the computer readable medium on which the program is recorded can be a non-transitory recording medium. Though the non-transitory recording medium is not particularly limited, it can be a recording medium such as a CD-ROM and/or a DVD-ROM, for example.

As explained above, according to the present invention, in a case in which a classification result from an nth-level is corrected, the correction can be automatically reflected in the classifier results of the classifiers in the levels above the Nth-level by following the dependencies of the classification/prediction of multiple levels. Thus, training data for all levels can be efficiently generated. Further, because it is possible to set not only points corrected by the user, but also points not corrected by the user, as training data that has been confirmed by the user, a large amount of training data can be prepared. Thus, it is possible to efficiently generate learning data for each of the classifiers.

Further, according to the present invention, by displaying a learning form having the classification results for multiple levels and a correction interface for rectifying the classification results the user can readily perform correction of the classification results, and operability can be improved.

Although the above embodiments have been described as typical examples, it will be evident to skilled person that many modifications and substitutions are possible within the spirit and scope of the present invention. Therefore, the present invention should not be construed as being limited by the above embodiments, and various changes and modifications and the like can be made without departing from the claims. For example, it is possible to combine a plurality of constituent blocks described in the configuration diagram of the embodiment into one, or to divide one constituent block.

### REFERENCE SIGNS LIST

1 learning data generation device
2 display
11 classification dependency relation store
12 multi-class classifier
13 learning form generation unit
14 corrected point record unit
15 learning scope determination unit
16 training data generation unit
21-25 first display region
221, 231, 241 second display region
222, 232, 242 third display region
223 topic display region

1. A learning data generation device for generating learning data in a system that performs classification of an input data group using a plurality of classifiers that are combined hierarchically, the learning data generation device comprising:
a computer that determines input data to be a learning scope, on the basis of classification results from a multi-class classification of the input data group using the plurality of classifiers, and
generates training data that is the input data determined to be the learning scope to which the classification results of the input data are appended as labels.

2. The learning data generation device according to claim 1, wherein the computer inputs a corrected point and a corrected classification result when a correction is made by a user, and
determines the learning scope to be one or more consecutive input data that include input data corresponding to the corrected classification result and have the same classification result of the top level classifier.

3. The learning data generation device according to claim 2, wherein the computer, when a classification result of a classifier of a particular level is corrected, corrects classification results of classifiers of levels higher than said particular level to conform to the correction of the classification result, or excludes classification results of classifiers of levels lower than said particular level from the training data.

4. A learning data generation device for generating learning data in a system that performs classification of input data groups using classifiers, the learning data generation device comprising:
a computer that determines input data to be a learning scope, on the basis of classification results from a classification of the input data group using the classifiers,
generates training data that is the input data determined to be the learning scope to which the classification results of the input data area appended as labels, and
inputs a corrected point and a corrected classification result when a correction is made by a user,
wherein the computer determines the learning scope to be one or more consecutive input data that include input data corresponding to the corrected classification result.

5. The learning data generation device according to claim 1,
wherein the computer performs a multi-class classification of the input data group using a plurality of classifiers and generates classification results, and
generates a learning form having the classification results and a correction interface for rectifying the classification results and causes the learning form to be displayed on a display, and
the classification results are corrected using the correction interface displayed on the display.

6. The learning data generation device according to claim 5, wherein the computer generates a learning form which shows, in a categorized manner for the respective classification results, the classification results from the top level classifier, and shows, within a region for displaying the classification results of the top level classifier, classification results for the classifiers of the respective lower levels.

7. The learning data generation device according to claim 5, wherein the computer generates a correction interface including a button for adding a classification result, a button for deleting a classification result, and a region for inputting a corrected classification result.

8. A learning data generation method for generating learning data in a system that performs classification of an input data group using a plurality of classifiers that are combined hierarchically, the learning data generation method comprising:
determining input data to be a learning scope, on the basis of classification results from a multi-class classification of the input data group using the plurality of classifiers; and
generating training data that is the input data determined to be the learning scope to which the classification results of the input data are appended as labels.

9. A non-transitory computer readable recording medium recording a program for causing a computer to function as a learning data generation device according to claim 1.

10. The learning data generation device according to claim 2,
wherein the computer
performs a multilevel classification of the input data group using a plurality of classifiers and generates classification results, and
generates a learning screen having the classification results and a rectification interface for rectifying the classification results and causes the learning screen to be displayed on a display, and
the classification results are rectified using the rectification interface displayed on the display.

11. The learning data generation device according to claim 3,
wherein the computer
performs a multilevel classification of the input data group using a plurality of classifiers and generates classification results; and
generates a learning screen having the classification results and a rectification interface for rectifying the classification results and causes the learning screen to be displayed on a display, and
the classification results are rectified using the rectification interface displayed on the display.

12. The learning data generation device according to claim 4,
wherein the computer
performs a multilevel classification of the input data group using a plurality of classifiers and generates classification results, and
generates a learning screen having the classification results and a rectification interface for rectifying the classification results and causes the learning screen to be displayed on a display, and
the classification results are rectified using the rectification interface displayed on the display.

13. The learning data generation device according to claim 6, wherein the computer generates a rectification interface including a button for adding a classification result, a button for deleting a classification result, and a region for inputting a rectified classification result.
